(19) United States
(12) Patent Application Publication
(10) Pub. No.: US 2001/0020247 A1
(43) Pub. Date: Sep. 6, 2001

(54) Electronic mail processing method, electronic mail processing system and transmission medium used therein

(76) Inventors: Minoru Ikeda, Inagi (JP); Daisuke Iseki, Tokyo (JP); Asako Katayama, Kodaira (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/797,722

(22) Filed: Mar. 5, 2001

(30) Foreign Application Priority Data
Mar. 3, 2000 (JP) 12-063276

(51) Int. Cl. G06F 15/16

(52) U.S. Cl. 709/206; 709/207; 709/204

(57) ABSTRACT

An electronic mail processing method for transmitting/receiving an electronic mail by a mail server between a sender terminal and a receiver terminal via a communication line. Text data as a main text, image data as an attached file, and scenario data having data on a display order and time of the text data and the image data are received. The received data are edited into an edited mail to be automatically displayed in accordance with the display order and the time, and transmitted to the receiver terminal. Thus the receiver can easily inspect the content of electronic mail.

### BACKGROUND OF THE INVENTION

The present invention relates to an electronic mail processing method, an electronic mail processing system and a transmission medium used therein, and more particularly, to an electronic mail processing method and electronic mail processing system utilizing communication line of internet, intranet, radio communication or the like and a transmission medium used therein.

In recent popularized use of electronic mail, electronic-mail communication with a destination party can be easily made.

For example, JP-A No. H11-328056 discloses transmission and reception of various electronic mails including image information by combined use of cellular phone and television device (First prior art).

Further, JP-A No. H11-53154 discloses automatically displaying the content of electronic mail, received during other operation, on a display screen (Second prior art). Note that as the automatically-displayed content, settings of a sender, a main text and the like are made in advance.

However, in the first prior art, although the use of television display screen for electronic mail is proposed, any particular processing method therefor is not disclosed.

Further, in the second prior art, although a new window can be opened on the display screen to sequentially display a destination, a date and a main text based on the predetermined conditions, the displayed content is merely a text portion of electronic mail without any description about attached data. That is, in the second prior art, the summary of the electronic mail can be quickly known, but when attached data is checked, the electronic mail must be newly opened so as to see the attached data.

### SUMMARY OF THE INVENTION

The present invention has been made in consideration of the above situation, and provides an electronic mail processing method and an electronic mail processing system and a transmission medium used therein for enabling a receiver of electronic mail to easily check the content of received electronic mail.

According to the present invention, as a typical example to attain the above object, provided is an electronic mail processing method for a mail server which transmits/receives an electronic mail between a sender terminal and a receiver terminal via a communication line, comprising the steps of: receiving scenario data where a display order and display time of text data and an attached file including image data can be set, from the sender terminal; and transmitting an edited mail to automatically display the text data and the attached file in accordance with the display order and the display time set in the scenario data, to the receiver terminal.

Further, according to the present invention, provided are an electronic mail processing system wherein the electronic mail processing method can be realized and a transmission medium used in the system.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram showing the construction of electronic mail system according to an embodiment of the present invention;

FIG. 2 is a block diagram showing the construction of sender terminal used in the electronic mail system in FIG. 1;

FIG. 3 is a block diagram showing the construction of mail server used in the electronic mail system in FIG. 1;

FIG. 4 is a block diagram showing the construction of receiver terminal used in the electronic mail system in FIG. 1;

FIG. 5 is a table showing the structure of transmission data from the sender terminal to the mail server in the electronic mail system in FIG. 1;

FIGS. 6A to 6D are flowcharts showing the operation in the electronic mail system in FIG. 1;

FIG. 7 is a display image example of the sender terminal in the electronic mail system in FIG. 1;

FIGS. 8 to 16 are display image examples of the sender terminal in the electronic mail system in FIG. 1.

### DETAILED DESCRIPTION OF THE PREFERRED EMBODIMENT

A preferred embodiment of the present invention will be described in accordance with the accompanying drawings.

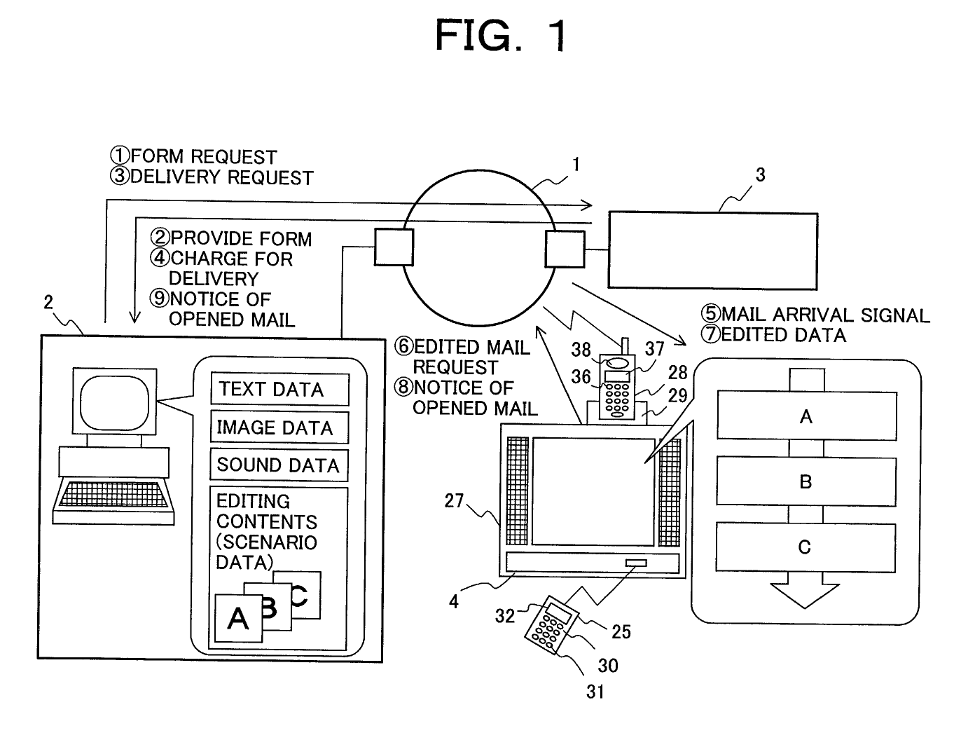

First, an electronic mail system of the present invention will be described with reference to FIG. 1. FIG. 1 shows the construction of the electronic mail system according to an embodiment of the present invention.

In the electronic mail system, plural sender terminals 2 are connected to a mail server 3 via a communication line 1 of Internet, Intranet, radio communication or the like, and plural receiver terminals 4 are connected to the mail server 3 via the communication line 1. The sender terminal 2 performs transmission/reception with the mail server 3 via the communication line 1, and the receiver terminal 4 performs transmission/reception with the mail server 3 via the communication 1, thereby the sender terminal 2 can transmit an electronic mail, via the communication line 1 and the mail server 3, to the receiver terminal 4.

Next, the outline of the transmission/reception in the electronic mail system will be described.

When the sender terminal 2 requires the mail server 3 for a format necessary for generating an electronic mail, the mail server 3 provides the sender terminal 2 with various formats. At the sender terminal 2, predetermined input is made based on the provided format, and the sender terminal 2 makes a delivery request to the mail server 3. Then the mail server 3 charges the sender terminal 2 for the delivery and transmits a mail arrival signal to the receiver terminal 4.

When the receiver terminal 4 receives the arrival signal, an edited mail request signal is transmitted by depression of mail operration button of the receiver terminal 4, from the receiver terminal 4 to the mail server 3. The mail server 3 transmits an edited mail to the receiver terminal 4.

Then, the content of the mail is displayed on the receiver terminal 4, and the receiver terminal 4 automatically transmits a notice of opened mail signal to the mail server 3. Further, the notice of opened mail signal is automatically transferred from the mail server 3 to the sender terminal 2. Thus the sender can check that the receiver has opened the mail.

As described above, since the sender can obtain various formats for input from the provider, it is not necessary to store the various formats for input in the sender terminal 2. Accordingly, the storage capacity of the sender terminal 2 can be saved. Further, since the various formats are stored only in the common mail server 3, only the formats stored in the mail server 3 may be changed in format change, and further, the change can be easily made. Furthermore, the plural senders can use the changed latest formats.

Further, in a case where the receiver terminal 4 transmits the edited mail request signal to the mail server 3, the mail server 3 transmits an edited mail to the receiver terminal 4. As the selection signal is transmitted such that the receiver can inspect the electronic mail, the edited mail is transmitted from the mail server 3 to the receiver terminal 4, and sequentially displayed for inspection of mail contents. Accordingly, the receiver who uses the receiver terminal 4 can see the content of mail merely by depressing the mail operation button. For example, if the mail inspection button is set in an available channel of a television-set remote control device, mail inspection can be made by the same operation as the television station selection. In this manner, a convenient mail system can be provided to an operation-unaccustomed receiver.

Especially, as one of significant features of the embodiment is that the sender functions as a television station which prepares a program (mail) for the receiver as a viewer of the program (mail). That is, in the system, the sender can easily generate a mail, and the receiver can inspect the mail without awkwardness with a simple operation such as manipulating a television set. Further, it is not necessary to store all the mail contents in the receiver terminal 4 before mail inspection. Further, it is possible to inspect large amount data such as image data at the simple receiver terminal 4.

Note that as long as the capacity of the storage device of the receiver terminal 4 permits, it may be arranged such that all the edited mails can be stored in the receiver terminal 4 while they are inspected.

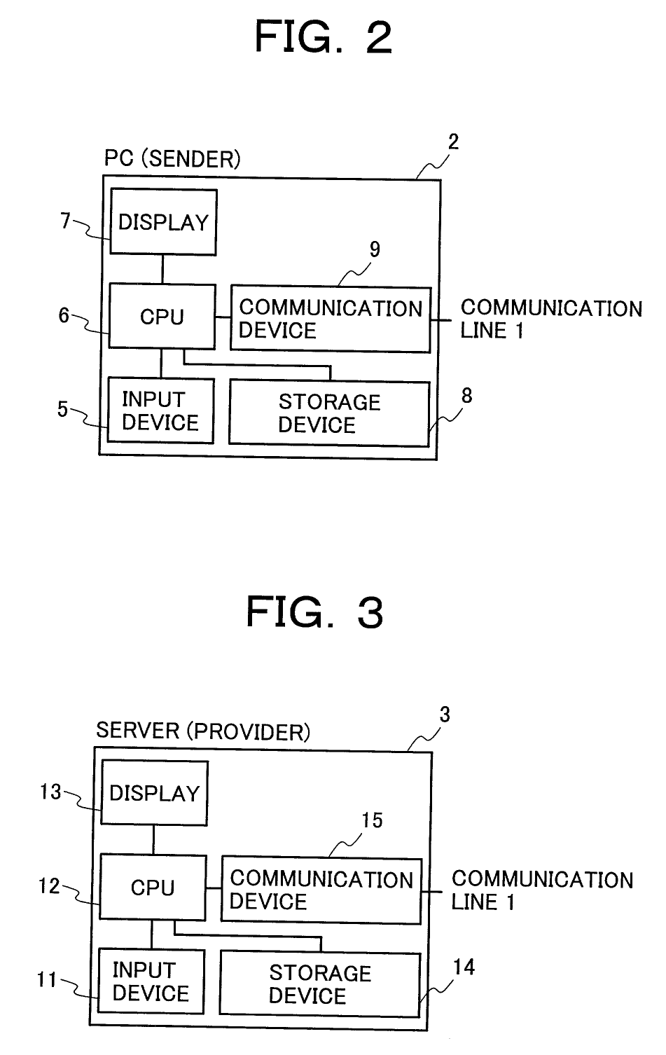

Next, the sender terminal 2 operated by the sender will be described with reference to FIG. 2. FIG. 2 shows the construction of the sender terminal used in the electronic mail system in FIG. 1.

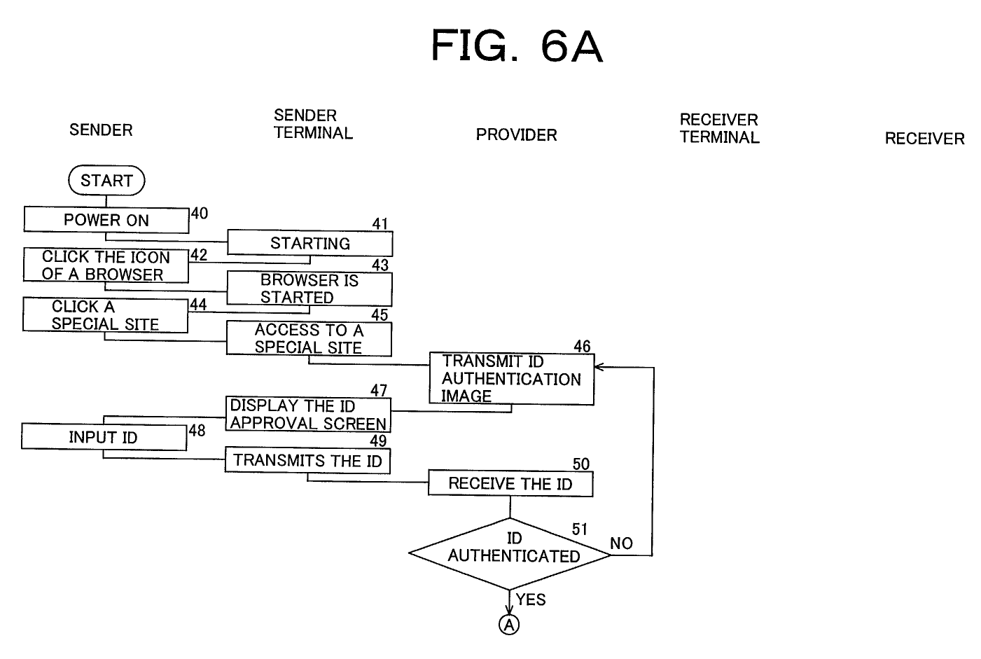

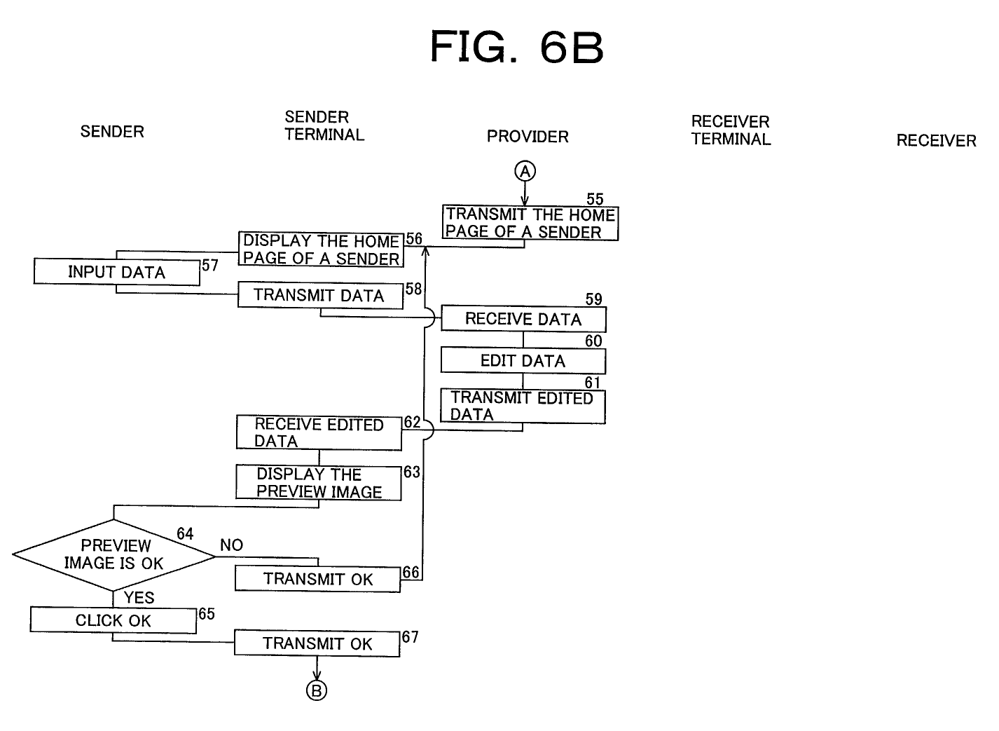

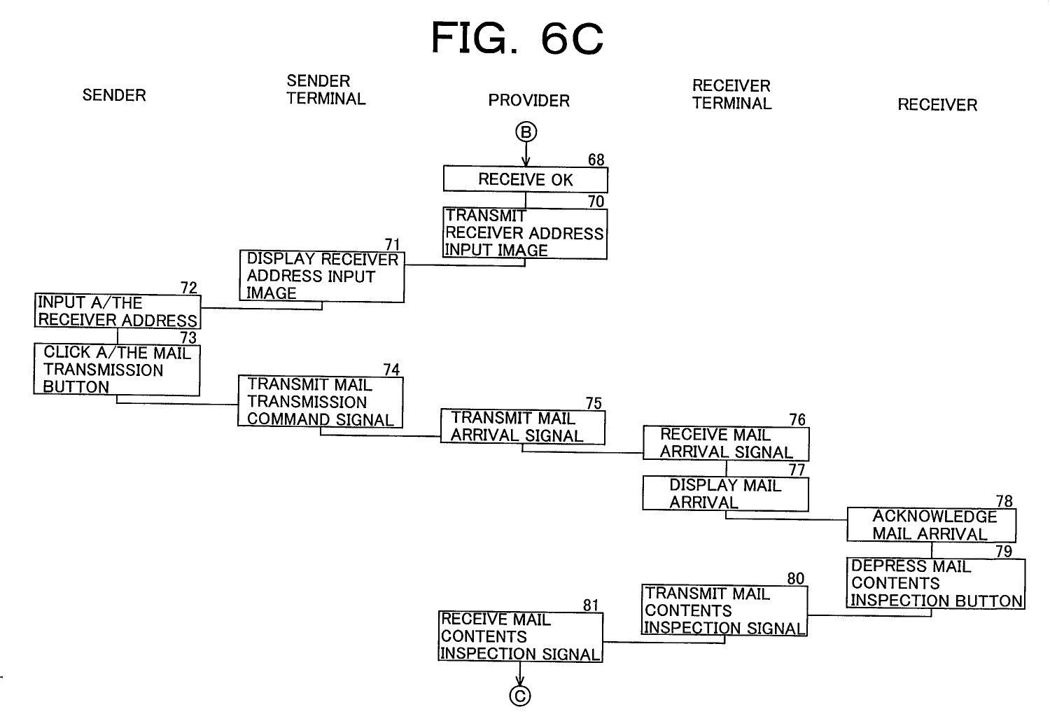

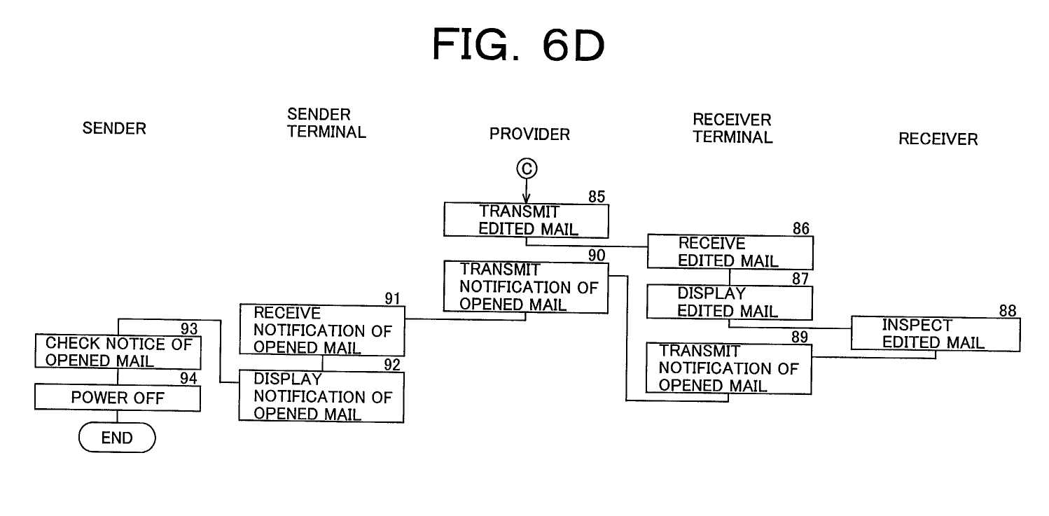

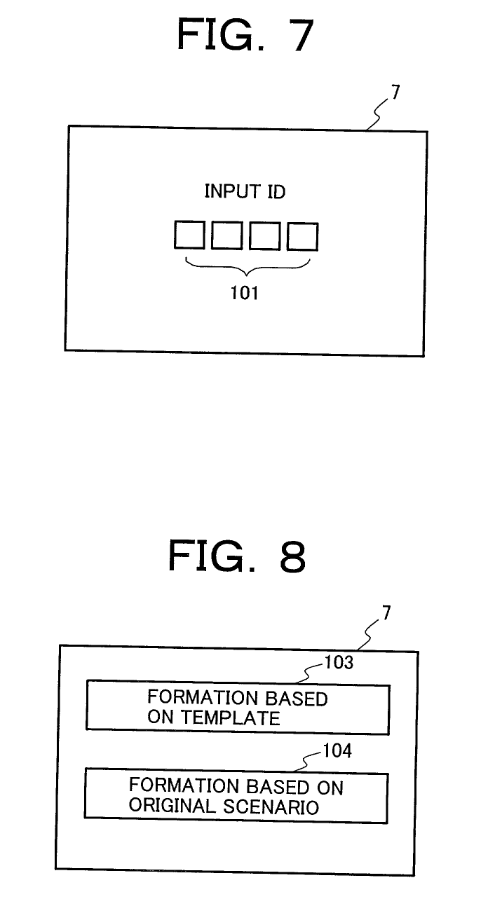

The sender terminal 2 which is a personal computer or the like has an input device 5, a control device 6, a display device 7, a storage device 8 and a communication device 9. The input device 5 has a character input unit such as a keyboard, an image input unit such as an image reading device or an electronic image input device, and an voice input unit such as a microphone, and is connected to the control device 6. The control device 6 which is a microcomputer or the like performs predetermined processing. The processing will be described later with reference to FIG. 6. The display device 7 which is a CRT display, a liquid crystal display device or the like is connected to the control device 6, for displaying input contents, received contents and the like. The display content will be described later with reference to FIG. 7. The storage device 8, in which information unique to the sender is stored, is connected to the control device 6. The communication device 9, having a function to enable the sender terminal 2 to perform transmission/reception via the communication line 1, is connected between the communication line 1 and the control device 6.

Next, the mail server 3 operated by the provider will be described with reference to FIG. 3. FIG. 3 shows the construction of the mail server used in the electronic mail system in FIG. 1.

The mail server 3 has an input device 11, a control device 12, a display device 13, a storage device 14 and a communication device 15. The input device 11, having an input unit such as a keyboard, is connected to the control device 12. The control device 12 which is a microcomputer or the like performs predetermined processing. Note that the processing method will be described later with reference to FIG. 6. The display device 13 which is a CRT display, a liquid crystal display or the like is connected to the control device 12, for displaying transmission/reception images, input images and the like necessary for the provider. The storage device 14 for storing information unique to the provider is connected to the control device 12. Especially, in the storage device 14, various formats to be provided to the sender are also stored as unique information. The communication device 15 has a function to enable transmission/reception between the control device 12 and the communication line 1.

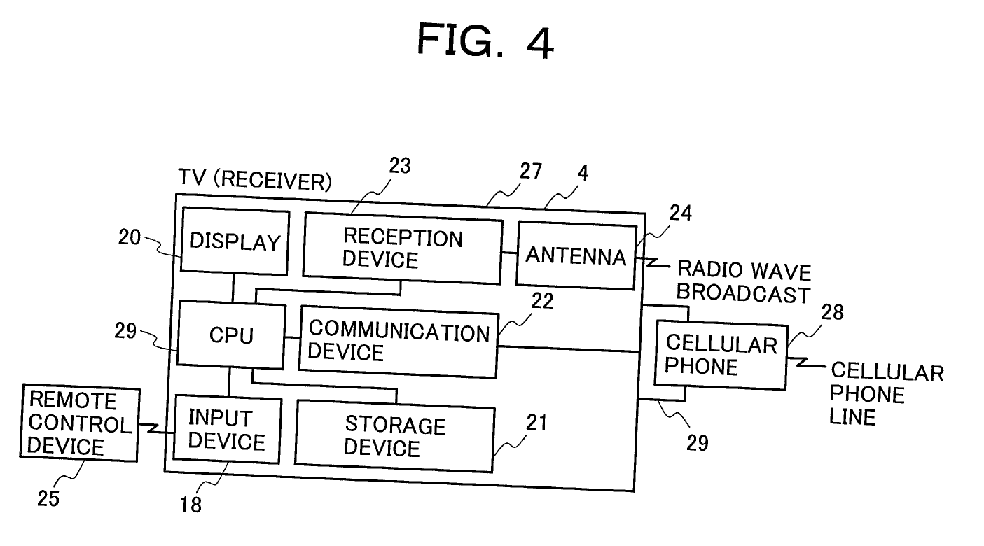

Next, the receiver terminal 4 operated by the receiver will be described with reference to FIGS. 4 and 1. FIG. 4 shows the construction of the receiver terminal used in the electronic mail system in FIG. 1.

The receiver terminal 4 has a television set 27, a cellular phone 28 and a charger adapter 29 connecting the television set 27 and the cellular phone 28. In this construction using the electronic mail system, it is not necessary for the receiver to newly obtain a telephone number.

The television set 27 has an input device 18, a control device 19, a display device 20, a storage device 21, a communication device 22, a reception device 23, an antenna 24 and a remote control device 25. The input device 18, connected to the control device 19, receives a signal transmitted from the remote control device 25 and inputs the received content into the control device 19. The control device 19 which is a microcomputer performs control processing to provide predetermined functions as a television set and performs predetermined processing by the electronic mail system. the processing method by the electronic mail system will be described later with reference to FIG. 6. The display device 20, which is a CRT display in this example, may be a CRT display, a liquid crystal display or the like. The display device 20 is connected to the control device 19 for displaying television broadcast images, electronic-mail transmission/reception images and the like. The storage device 21, for storing information unique to the receiver, is connected to the control device 19. The communication device 22 has a function to enable transmission/reception between the control device 19 and the communication line 1. The reception device 23, connected to the antenna 24, receives a television broadcast radio wave. The reception device 23 is connected to the control device 19.

The adapter 29 is connected to the television set 27, more specifically, connected to the communication device 22. The cellular phone 28 can be used as a portable telephone. When the cellular phone 28 is attached to the adapter 29, the receiver terminal 4 has a function of telephone-attached television to perform electronic-mail transmission/reception with the mail server 3 via the cellular phone 28. Further, the cellular phone 28 has telephone number buttons 36, a display unit 37 for displaying transmission/reception state and an execution button 38. The remote control device 25 has a broadcast operation button 30 for reception of normal television broadcast signal, a mail operation button 31 for electronic-mail transmission/reception and a display unit 32 for displaying television state. In the receiver terminal 4, as one of available channels is allocated to the mail operation button 31, electronic mail inspection can be made by merely depressing the mail operation button 31, thus provides excellent operability.

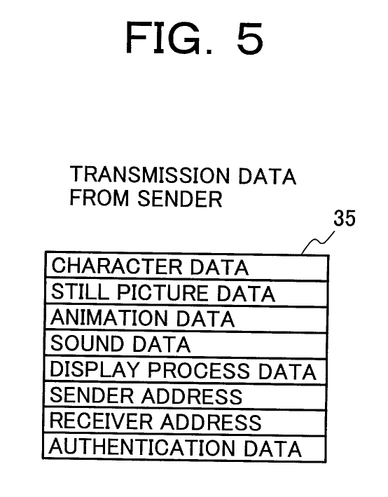

Next, the structure of transmission data sent from the sender terminal 2 will be described with reference to FIG. 5. FIG. 5 shows the structure of transmission data from the sender terminal to the mail server in the electronic mail system in FIG. 1.

As shown in FIG. 5, transmission data 35 sent from the sender terminal 2 to the mail server 3 includes character data, still picture data, moving picture data, voice data, display process data, a sender address, a receiver address and authentication data.

Next, the operation of the electronic mail system will be described with reference to FIGS. 6A to 6D and FIGS. 7 to 16. FIGS. 6A to 6D are flowcharts showing the operation of the electronic mail system in FIG. 1. FIGS. 7 to 16 are examples of display images on the sender terminal in the electronic mail system in FIG. 1.

First, the sender turns the power on (step 40) to start the sender terminal 2 (step 41), then clicks an icon of browser displayed on the screen of the sender terminal 2 (step 42), to start the browser of the sender terminal 2 (step 43). The browser start operation is similar to that generally performed in use of the communication line 1.

In this state, the sender clicks a particular site to utilize the electronic mail system (step 44), thereby the sender terminal accesses the particular site (step 45).

By this access, ID authentication image data is automatically transmitted from the mail server 3 to the sender terminal 2 (step 46), and an image as shown in FIG. 7 is displayed on the display device 7 of the receiver terminal 2 (step 47). Then the sender inputs an ID into an ID input field of the image (step 48), thereby the ID is transmitted from the sender terminal 2 to the mail server 3 (step 49). When the mail server 3 receives the ID (step 50), it is determined whether or not the ID authentication is OK (step 51). If the ID authentication is not OK, the process returns to step 46, at which the transmission of the ID authentication image is repeated. Further, if the ID authentication is OK, a homepage of sender having various format data is transmitted from the mail server 3 to the sender terminal 2 (step 55). Note that the ID authentication operation is similar to that generally performed for ID authentication.

When the sender terminal 2 receives the homepage of sender, the homepage is displayed on the display device 7 of the sender terminal 2 (step 56). The homepage of sender is as shown in FIGS. 8 to 15. The sender inputs data based on the images (step 57), thereby the sender 2 transmits the input data to the mail server 3 (step 58).

Next, the method for data input based on the images of the homepage of sender will be described with reference to FIGS. 8 to 15.

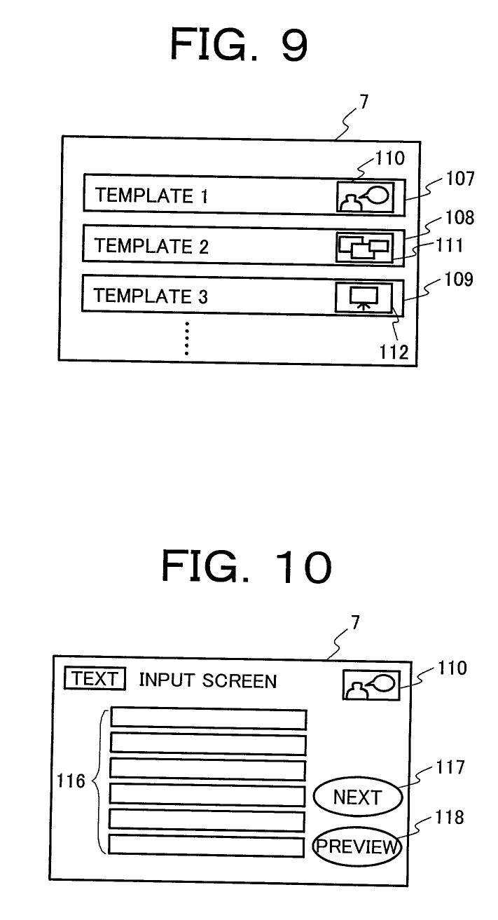

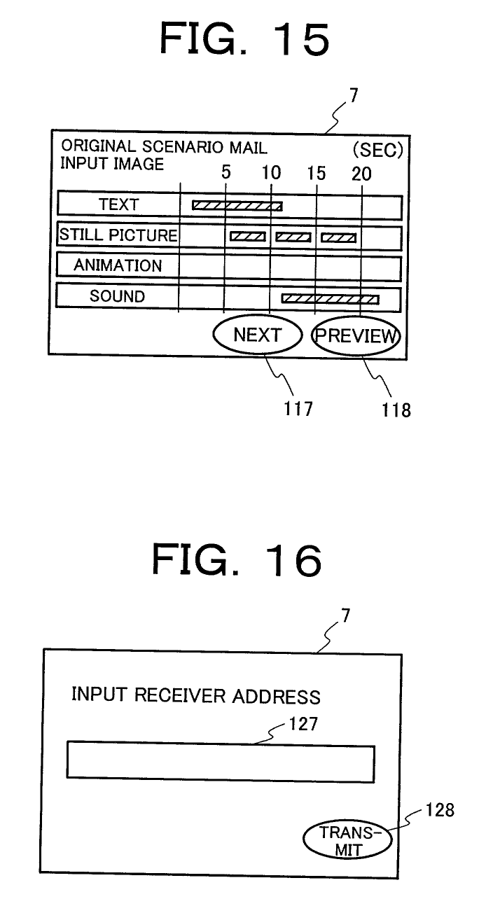

In the homepage of sender, an image as shown in FIG. 8 is first displayed, and the input is started from this image. The image has a “Formation Based On Template” button 103 and a “Formation Based On Original Scenario” button 104. If the “Formation Based On Template” button 103 is selected, as the order and time to output text data, still picture data, moving picture data and voice data, desired one of various templates as shown in FIG. 9 is selected, and input is made based on the selected template in images from FIGS. 10 to 13. On the other hand, if the “Formation Based On Original Scenario” button 104 is selected, the order and time to output text data, still picture data, moving picture data and voice data can be freely set from a free setting image as shown in FIG. 15, and input is made based on the settings in images from FIGS. 10 to 13.

That is, in the embodiment, data formation based on template and that based on original setting commonly have data constructing the transmission data 35, i.e., character data, still picture data, moving picture data, voice data, and display process data. The difference is that the display process data is fixed or not.

For example, the data generated based on the original scenario and that based on the template both have the display process data as shown in FIG. 15. However, in generation of data based on the original scenario, the display process data is displayed as an original mail input image as shown in FIG. 15, and the user freely makes settings via this input image.

More specifically, in the input image in FIG. 15, the horizontal axis represents time, the vertical axis, respective data, and the horizontal bands, execution time. For example, in this image, from the start, the text data is displayed at 00:00:02 and the data disappears at 00:00:12. Further, the still picture is first displayed at 00:00:06, then again displayed at 00:00:11, and displayed at 00:00:16. In the original data, there is no moving picture, and a sound is emitted between 00:00:11 and 00:00:23.

In these various settings, additional data setting may be added or some setting may be deleted in a displayed operation window (not shown) in the input image in FIG. 15. For example, in FIG. 15, if a cursor is moved to the moving data field and addition is designated in the operation window, the moving data can be added. Further, if the cursor is moved to one of the band portions of the respective data, the band portion is made active state by the click of mouse or the like, and in this state, the band may be contracted or expanded leftward/rightward, thereby the start and end and execution time can be set. In the example of FIG. 15, the respective data can be sequentially set by depressing a “Next” button 117. However, the double click of mouse or the like may move the operation to input image of the respective data. In this manner, input and/or correction on a particular input image can be easily made.

In the displayed image in FIG. 8, if the “Formation Based On Template” button 103 is selected, an image as shown in FIG. 9 is displayed. The image has a “Template 1” button 107, a “Template 2” button 108 and a “Template 3” button 109. In the respective buttons 107 to 109, moving pictures 110 to 112 corresponding to the contents of the respective templates are displayed. Note that the moving picture is displayed in a part of input image of selected template for the user's recognition of selected template with ease.

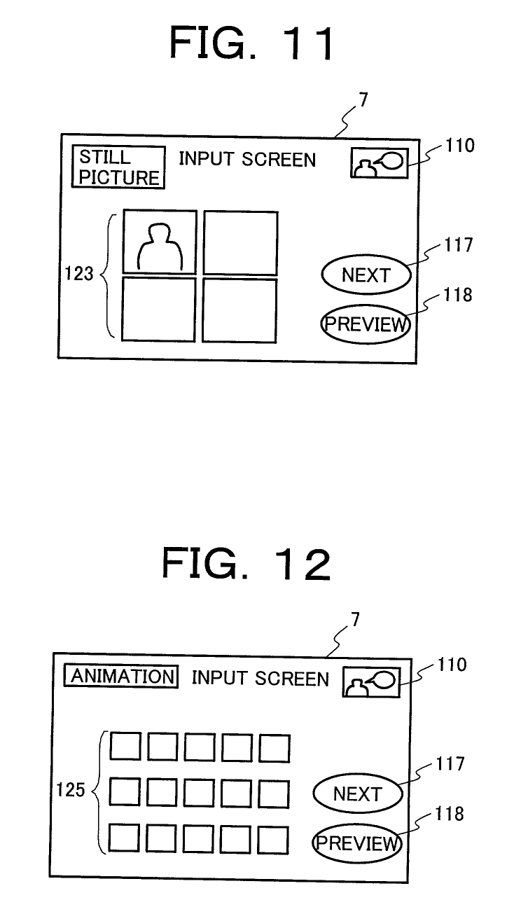

In the image in FIG. 9, if the “Template 1” button 107 is selected, an image as shown in FIG. 10 is displayed. Since the image has an input field 116 for inputting a predetermined length of text data as a mail text, a mail text of a length within the input field 116 is inputted in text format, and the “Next” button 117 is clicked, thereby an image as shown in FIG. 11 is displayed. In a case where text data is not inputted, immediately the “Next” button 117 is clicked, thereby an image as shown in FIG. 12 is displayed. In a case where the user desires to check the result of input in output format, a “Preview” button 118 is clicked, thereby a preview image as shown in FIG. 14 is displayed. When an “OK” button 119 is clicked in the preview image, the initial image is restored. The preview function is also available in the respective images in FIGS. 11 to 13.

Since the displayed image in FIG. 11 has an input field 123 for inputting a still picture such as a photograph obtained by a digital camera or the like, a still picture is inputted into the input field 123, then the “Next” button 117 is clicked, thereby the image as shown in FIG. 12 is displayed.

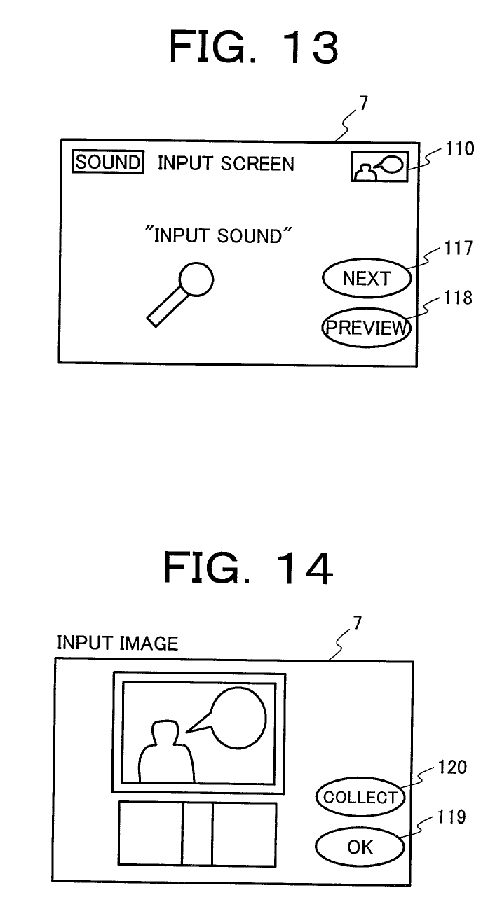

As the displayed image in FIG. 12 has an input field 125 for inputting a moving picture such as video image obtained by a video camera or the like, a moving picture is inputted into the input field 125, thenthe “Next” button 117 is clicked, thereby the image as shown in FIG. 13 is displayed. Note that the above still picture data and moving picture data are attached to the electronic mail.

In the displayed image in FIG. 13, as voice information can be inputted from a microphone or the like, a voice or the like is inputted from the microphone, then the “Next” button 117 is clicked, thereby the input data is transmitted from the sender terminal 2 to the mail server 3 (step 58). The transmission data has the data structure as shown in FIG. 5 without the receiver address.

Note that in the embodiment, the input from FIGS. 11 to FIG. 13 may be performed by double click of mouse or the like in a corresponding input area or on an icon of microphone or the like, to display an operation window (not shown) where the recording place and name of recorded data are designated.

Next, if the “Formation Based On Original Scenario” button 104 is selected in the image in FIG. 8, the image as shown in FIG. 15 is displayed. In this image, the order and the time of output of the text data, the still picture data, the moving picture data and the voice data can be set. In the example of FIG. 15, the text data, the still picture data and the voice data are set to the output represented as the band portions. After the setting, the “Next” button 117 is clicked, thereby input images of the respective data are sequentially displayed similarly in FIGS. 10 to 13. In the input image, input can be made within a predetermined range, and the input method is similar to the above-described input method.

When the mail server 3 receives the data (step 59), the received data is edited (step 60), and the edited mail is transmitted to the sender terminal 2 (step 61). In this manner, as the mail server 3 prepares an edited mail, it is not necessary to provide the sender terminal 2 and the receiver terminal 4 with data editing software. The mail can be easily viewed by receiving the mail by the sender terminal 2 and the receiver terminal 4.

When the receiver terminal 2 receives the edited mail (step 62), the preview image as shown in FIG. 14 is displayed. The sender checks the preview image, and if it is OK, clicks the “OK” button 119 (step 65), while if correction or the like is necessary, clicks a “Correct” button 120 (step 66). If the “Correct” button 120 is clicked, the process returns to step 56, then data correction input can be made from step 57. Further, if the “OK” button 119 is clicked, an OK signal is transmitted from the sender terminal 2 to the mail server 3 (step 67).

As described above, in this electronic mail, as scenario data to automatically display text data as main text and image data and voice data as attached files, freely combined by the sender, in addition to destination data, is generated at the sender terminal 2, the sender obtains ease of use.

When the mail server 3 receives the OK signal (step 68), the mail server 3 transmits a receiver address input image to the sender terminal 2 (step 70), thereby a receiver address input image as shown in FIG. 16 is displayed on the sender terminal 2 (step 71).

As the image shown in FIG. 16 has a receiver address input field 127, the sender inputs a receiver address into the input field 127 (step 72) then clicks a “Transmit” button 128 (step 73), thereby the sender terminal 2 transmits a mail transmission command signal to the mail server 3 (step 74). The mail server 3 receives the mail transmission command signal, and transmits the mail arrival signal to the receiver terminal 4 (step 75).

As described above, in this electronic mail system, it is not necessary for the sender to prepare data editing software in the sender terminal 2. The sender can easily perform input at the sender terminal 2 based on an edited mail transmitted from the mail server 3. Thus the system provides excellent operability.

When the cellular phone 28 of the receiver terminal 4 receives the mail arrival signal (step 76), the mail arrival signal is displayed on the display unit 37 or voice message output or the like is made (step 77). The receiver checks the mail arrival signal (step 78) then depresses the mail operation button 31 (step 79), thereby the receiver terminal 4 transmits the edited mail request signal to the mail server 3 (step 80).

When the mail server 3 receives the edited mail request signal (step 81), the mail server 3 transmits the edited mail to the receiver terminal 4 (step 85). The receiver terminal 4 receives the mail (step 86), and the edited mail is displayed on the television set 27 of the receiver terminal 4 (step 87). As shown in FIG. 1, the display is made such that edited mails A to C are automatically displayed on the receiver terminal 4 in accordance with the edited order and time. When the receiver has inspected the edited mails and the display is terminated (step 88), the receiver terminal 4 transmits the notice of opened mail signal to the mail server 3 (step 89).

When the mail server 3 receives the notice of opened mail signal, the mail server 3 transmits the notice of opened mail signal to the sender terminal 2 (step 90). The sender terminal 2 receives the notice of opened mail signal (step 91), and displays notification of notice of opened mail on the display device 7 (step 92). The sender checks the notice of opened mail (step 93), and turns the power off (step 94), thereby the process ends.

As described above, in the electronic mail system, the receiver can inspect electronic mails on the television set 27 as if the receiver watches a television broadcast program, by depressing the mail operation button 31. In this manner, even a receiver who is unaccustomed to electronic mail can easily inspect the contents of electronic mails.

Accordingly, the present invention provides an electronic mail processing method and an electronic mail processing system for enabling a receiver to easily inspect the content of electronic mail and a transmission medium used in the system.

As many apparently widely different embodiments of the present invention can be made without departing from the spirit and scope thereof, it is to be understood that the invention is not limited to the specific embodiments thereof except as defined in the appended claims.

What is claimed is:

1. An electronic mail processing method for a mail server which transmits/receives an electronic mail between a sender terminal and a receiver terminal via a communication line, comprising the steps of:
receiving scenario data where a display order and display time of text data and an attached file including image data can be set, from said sender terminal; and
transmitting an edited mail to automatically display said text data and said attached file in accordance with the display order and the display time set in said scenario data, to said receiver terminal.

2. An electronic mail processing method for transmitting/receiving an electronic mail by a mail server between a sender terminal and a receiver terminal via a communication line, said method comprising the steps of:
receiving text data as a main text, image data as an attached file, and scenario data having data on a display order and time of the text data and the image data, from said sender terminal, into said mail server;
editing the data received at said reception step into an edited mail to be automatically displayed in accordance with the display order and the time set in said scenario data; and
transmitting said edited mail from said mail server to said receiver terminal.

3. An electronic mail processing method for transmitting/receiving an electronic mail by a mail server between a sender terminal and a receiver terminal via a communication line, said method comprising the steps of:
transmitting a scenario data format permitting input of text data as a main text and image data as an attached file and setting of a display order and time of the text data and the image data, from said mail server to said sender terminal;
receiving scenario data generated based on said form, from said sender terminal to said mail server;
editing the text data and the image data into an edited mail to be automatically displayed on said receiver terminal in accordance with the display order and the time set in said scenario data; and
transmitting said edited mail from said mail serer to said receiver terminal.

4. The electronic mail processing method according to claim 3, further comprising the step of:
transmitting said edited mail from said mail server to said sender terminal;
receiving a mail transmission command signal from said sender terminal into said mail server; and
transmitting said edited mail from said mail server to said receiver terminal based on said mail transmission command signal.

5. The electronic mail processing method according to claim 3, further comprising the steps of:
after said editing step, transmitting an mail arrival signal from said mail server to said receiver terminal;
receiving an edited mail request signal in response to said mail arrival signal from said receiver terminal to said mail server; and
after reception of the edited mail request signal from said receiver terminal, transmitting said edited mail from said mail server to said receiver terminal.

6. The electronic mail processing method according to claim 3, further comprising the steps of:
transmitting said edited mail from said mail server to said sender terminal;
receiving a mail transmission command signal from said sender terminal into said mail server;
after said editing step, transmitting a mail arrival signal from said mail server to said receiver terminal;
receiving an edited mail request signal in response to said mail arrival signal, from receiver terminal to said mail server;
after reception of the edited mail request signal from said receiver terminal, transmitting said edited mail from said mail server to said receiver terminal;
receiving a notice of opened mail signal from said receiver terminal into said mail server; and
a transmission step of, after reception of said notice of opened mail signal, transmitting the notice of opened mail signal from said mail server to said sender terminal.

7. An electronic mail processing system for a mail server which transmits/receives an electronic mail between a sender terminal and a receiver terminal via a communication line, comprising:
reception means for receiving scenario data having data on a display order and time of text data as a main text and image data as an attached file, from said sender terminal;
editing means for editing the text data and the image data into an edited mail to be automatically displayed on said receiver terminal in accordance with the display order and the time set in said scenario data; and
transmission means for transmitting said edited mail to said receiver terminal.

8. An electronic mail processing system for a mail server which transmits/receives an electronic mail between a sender terminal and a receiver terminal via a communication line, comprising:
reception means for receiving scenario data having data on a display order and time of text data as a main text and image data as an attached file, from said sender terminal via said communication line;
editing means for editing the text data and the image data into an edited mail to be automatically displayed on said receiver terminal in accordance with the display order and the time set in said scenario data; and
transmission means for transmitting said edited mail to said receiver terminal.

9. An electronic mail processing system for transmitting/receiving an electronic mail by a mail server between a sender terminal and a receiver terminal via a communication line,
wherein said mail server has a control device, a storage device and a communication device,
and wherein said control device has:
transmission means for transmitting a scenario data input format transmitted/received via said communication device, for setting text data as a main text and image data as an attached file in accordance with a predetermined display order and time, to said sender terminal;
reception means for receiving scenario data generated based on said format, from said sender terminal;
editing means for editing the text data and image data into an edited mail to be automatically displayed on said receiver terminal in accordance with the display order and the time set in said scenario data; and
transmission means for transmitting said edited mail to said receiver terminal.

10. The electronic mail processing system according to claim 9, further comprising:
means for transmitting said edited mail to said sender terminal;
means for receiving a mail transmission command signal from said sender terminal;
means for, after edition by said editing means, transmitting an mail arrival signal to said receiver terminal;
means for receiving an edited mail request signal in response to said mail arrival signal, from said receiver terminal;
means for, after reception of the edited mail request signal from said receiver terminal, transmitting said edited mail to said receiver terminal;
means for receiving a notice of opened mail signal from said receiver terminal; and
means for, after reception of said notice of opened mail signal, transmitting said notice of opened mail signal to said sender terminal.

11. A transmission medium used in an electronic mail processing system for transmitting/receiving an electronic mail by a mail server between a sender terminal and a receiver terminal via a communication line, said medium having scenario data including:
an input field for inputting text data as a main text;
an input field for inputting attached file including image data; and
a setting field for setting for automatically displaying said text data and said attached file on a display device of said receiver terminal in accordance with a predetermined display order and display time.

12. A transmission medium used in an electronic mail processing system for transmitting/receiving an electronic mail by a mail server between a sender terminal and a receiver terminal via a communication line, said medium having:
text data as a main text;
an attached file including image data; and
scenario data for automatically displaying said text data and said attached file on a display device of said receiver terminal in accordance with a predetermined display order and display time.
